(19) United States
(12) Patent Application Publication
(10) Pub. No.: US 2003/0147471 A1
(43) Pub. Date: Aug. 7, 2003

(54) Cross correlated trellis coded quatrature modulation transmitter and system

(76) Inventors: Marvin K. Simon, La Canada, CA (US); Tsun-Yee Yan, Northridge, CA (US)

Correspondence Address: SCOTT C. HARRIS, Fish & Richardson P.C., Suite 500, 4350 La Jolla Village Drive, San Diego, CA, 92122, US

(21) Appl. No.: 09/969,267

(22) Filed: Sep. 24, 2001

Related U.S. Application Data
(62) Division of application No. 09/496,135, filed on Feb. 1, 2000.
Application No. 09/496,135 is a continuation of application No. 09/412,348, filed on Oct. 5, 1999, now abandoned.
(60) Provisional application No. 60/103,227, filed on Oct. 5, 1998.

(51) Int. Cl. H04L 27/20; H04L 27/12; H04L 27/04

(52) U.S. Cl. 375/295; 375/302

(57) ABSTRACT

System of modulating information onto an arbitrary waveshape. The system trellis codes the modulation.

### CROSS-REFERENCE TO RELATED APPLICATIONS

This application is a divisional of U.S. application Ser. No. 09/496,135 filed Feb. 1, 2000, which is a continuation of U.S. application Ser. No. 09/412,348, filed Oct. 5, 1999, which claims priority to U.S. provisional application Ser. No. 60/103,227, filed Oct. 5, 1998.

### BACKGROUND

Information can be sent over a channel using modulation techniques. Better bandwidth efficiency allows this same channel to hold and carry more information. A number of different systems for efficiently transmitting over channels are known. Examples include Gaussian minimum shift keying, staggered quadrature overlapped raised cosine modulation, and Feher's patented quadrature phase shift keying.

Many of these systems provide a transmitted signal with a constant or pseudo-constant envelope. This is desirable when the transmitter has a nonlinear amplifier that operates in or near saturation.

Many of these phase shift keying signals systems can operate using limited groups of the information at any one time.

Trellis coded modulation techniques are well known. Trellis coded techniques operate using multi-level modulation techniques, and hence can be more efficient than symbol-by-symbol transmission techniques.

### SUMMARY

The present application teaches a special cross correlated trellis coded quadrature modulation technique that can be used with a variety of different transmission schemes. Unlike conventional systems that use constant envelopes for the modulating waveforms, the present system enables mapping onto an arbitrarily chosen waveform that is selected based on bandwidth efficiency for the particular channel.

The system uses a special cross correlator that carries out the mapping in a special way.

This system can be used with offset quadrature phase shift keying along with conventional encoders, matched filters, decoders and the like. The system uses a special form of trellis coding in the modulation process that shapes the power spectrum of the transmitted signal over and above bandwidth efficiency that is normally achieved by an M-ary (as opposed to binary) modulation.

### BRIEF DESCRIPTION OF THE DRAWINGS

These and other aspects of the invention will be described in detail with reference to the accompanying drawings, wherein:

FIG. 1 shows a basic block diagram of a preferred transmitter of the present application;

FIG. 2 shows a specific cross correlation mapper;

FIG. 3 shows a specific embodiment that is optimized for XPSK;

FIG. 4 shows waveforms for FQPSK;

FIG. 5 shows a block diagram of the system for FQPSK;

FIGS. 6a and 6b respectively show the waveforms for in phase and out of phase FQPSK outputs;

FIG. 7 shows a trellis diagram for FQPSK;

FIG. 8 shows an FQPSK shaper;

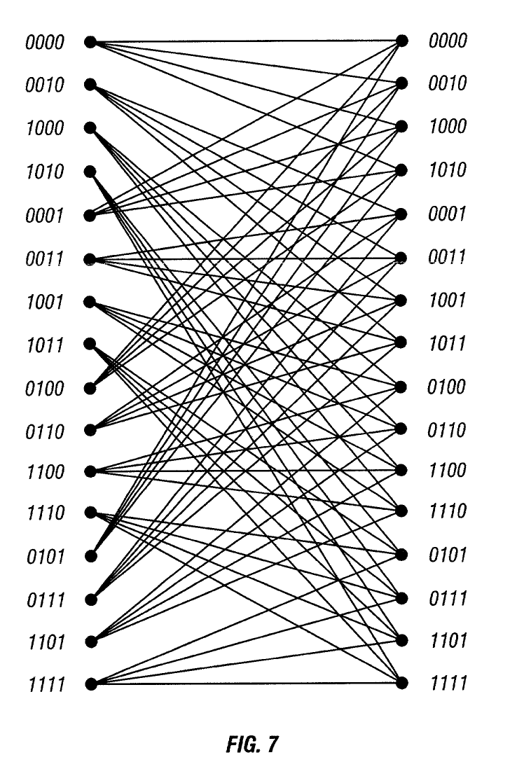

FIG. 9 shows waveforms for full symbols of OQPSK;

FIG. 10 shows a trellis coded OQPSK;

FIG. 11 shows a 2 state trellis diagram;

FIG. 12 shows an uncoded OQPSK transmitter; and

FIG. 13 shows paths.

### DETAILED DESCRIPTION

The present application describes a system with a transmitter that can operate using trellis coding techniques, which improve the operation as compared with the prior art techniques.

The present application focuses on the spectral occupancy of the transmitted signal. A special envelope property is described that improves the power efficiency of the demodulation and decoding operation. The disclosed structure is generic, and can be applied to different kinds of modulation including XPSK, FQPSK, SQORC, MSK and OP or OQPSK.

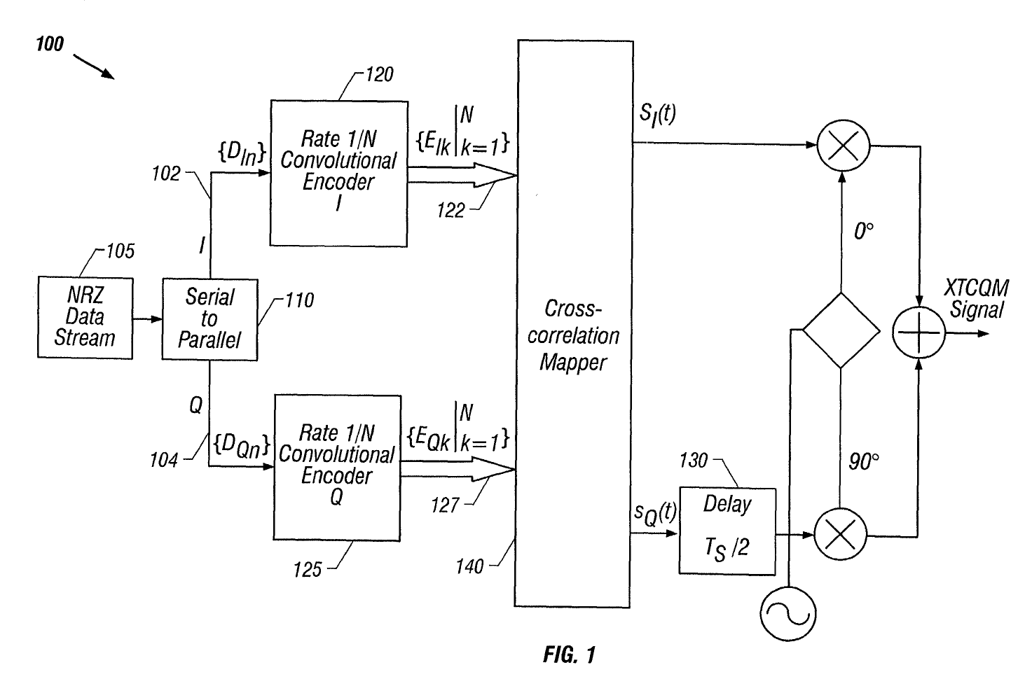

FIG. 1 shows a block diagram of a cross correlated quadrature modulation (XTCQM) transmitter 100.

An input binary (±1) datastream 105 is an independent, identically distributed information sequence {dₙ} at a bit rate R_{b}=1/T_{b}. A quadrature converter 110 separates this sequence into an inphase (I) sequence 102 and a quadriphase (Q) sequence 104 {dᵢₙ} and {d_{Qn}}. As conventional, every second bit becomes part of the different phase. Hence, the phases can be formed by the even and odd bits of the information bit sequence {dₙ}. The bits hence occur on the I and Q channels at a rate R [symbol] =1/T [symbol] =½Tₕ; where Tₕ is the bit rate, and T [symbol] is the symbol rate.

For this explanation, it is assumed that the I and Q sequences {d [symbol] } and {d_{Qn}} are time synchronous. Hence, each bit dₘ (or d_{Qn}) occurs during the interval (n−½)T,≦t≦(n+½)T [symbol] where n represents a count of adjacent symbol time periods T [symbol] .

Rather than analyzing these levels as extending from +1 to −1, it may be more convenient to work with the (0,1) equivalents of the I and Q data sequences. This can be defined as

$${D}_{I n} {=}^{Δ} \frac{1 - {d}_{I n}}{2} , \\ {D}_{Q n} {=}^{Δ} \frac{1 - {d}_{Q n}}{2} \qquad ( 1 )$$

which both range within the set (0,1). The sequences {D_{In}} and {D_{Qn}} are separately and respectively applied to rate r=1/N convolutional encoders 120, 125. The two encoders are in general different, i.e., they have different tap connections and different modulo 2 summers but are assumed to have the same code rate.

We can define

$$\{ {E}_{Ik} \vert \begin{matrix}N \\ k = 1\end{matrix} \} , \{ {E}_{Q k} \vert \begin{matrix}N \\ k = 1\end{matrix} \}$$

respectively as the sets of N(0,1) output symbols 122, 127 respectively, of the I and Q convolutional encoders 120, 125 corresponding to a single bit input to each of the encoders.

These sets of output symbols 122, 127 will be used to determine a pair of baseband waveforms sₜ(t).s_{Q}(t) which ultimately modulate I and Q carriers for transmission over the channel. The signal s_{Q}(t) is delayed by delay element 130 for T [symbol] /2=Tₕ seconds prior to modulation on the quadrature carrier. This delay offsets the signal s_{Q}(t) relative to the sₜ(t) signal, and thereby provides an offset modulation. Delaying the waveform by one half of a symbol at the output of the mapping allows synchronous demodulation and facilitates computation of the path metric at the receiver. This is different than the approach used for conventional FQPSK.

The present application teaches mapping of the symbol sets

$$\{ {E}_{Ik} \vert \begin{matrix}N \\ k = 1\end{matrix} \} and \{ {E}_{Q k} \vert \begin{matrix}N \\ k = 1\end{matrix} \}$$

into sₜ(t) and s_{Q}(t) using a waveform with a desired size and content (“waveshape”).

### Mapping

The mapping of the sets

$$\{ {E}_{lk} {\vert}_{k = 1}^{N} \} and \{ {E}_{Qk} {\vert}_{k = 1}^{N} \}$$

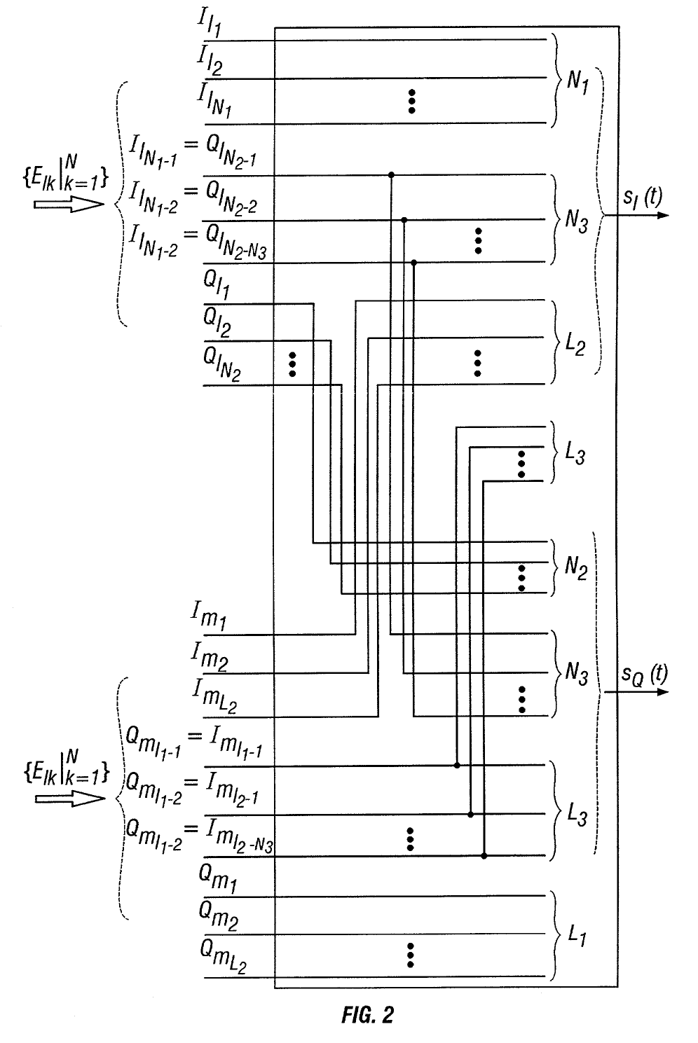

into sₜ(t) and s_{Q}(t) uses a crosscorrelation mapper 140. Details of the mapping is shown in FIG. 2. Each of these sets of N (0,1) output symbols is partitioned into one of three groups as follows.

The I and Q signals are separately processed. For the I signals, the first group uses

$${I}_{{l}_{1}} , {I}_{{l}_{2}} , … , {I}_{{N}_{1}}$$

as a subset of N₁ elements of

$$\{ {E}_{lk} {\vert}_{k = 1}^{N} \}$$

which will be used only in the selection of sₜ(t). The second group uses

$${Q}_{{l}_{1}} , {Q}_{{l}_{2}} , … , {Q}_{{N}_{2}}$$

as a subset N₂ elements of

$$\{ {E}_{lk} {\vert}_{k = 1}^{N} \}$$

which will be used only in the selection of s_{Q}(t). The third group uses

$${I}_{{l}_{{N}_{1} + 1}} , {I}_{{l}_{{N}_{1} + 2}} , … , {I}_{{l}_{{N}_{1} + {N}_{3}}} = {Q}_{{l}_{{N}_{2} + 1}} , {Q}_{{l}_{{N}_{2} + 2}} , … , {Q}_{{l}_{{N}_{2} + {N}_{3}}}$$

as a subset of N₃ elements of

$$\{ {E}_{lk} {\vert}_{k = 1}^{N} \}$$

which will be used both for the selection of sₜ(t) and s_{Q}(t). The term “crosscorrelation” in this context refers to the way in which the groups are formed.

All of the output symbols of the I encoder are used either to select sₜ(t)ₜs_{Q}(t) or both. Therefore, N₁+N₂+N₃=N.

A similar three part grouping of the Q encoder output symbols

$$\{ {E}_{Qk} {\vert}_{k = 1}^{N} \}$$

occurs. That is, for the first group let

$${Q}_{{m}_{1}} , {Q}_{{m}_{2}} , … , {Q}_{{m}_{{i}_{1}}}$$

be a subset L₁ elements of

$$\{ {E}_{Qk} {\vert}_{k = 1}^{N} \}$$

which will be used only in the selection of s_{Q}(t). For the second group, let

$${I}_{{m}_{1}} , {I}_{{m}_{2}} , … , {I}_{{m}_{{i}_{2}}}$$

be a subset of L₂ elements of

$$\{ {E}_{Qk} {\vert}_{k = 1}^{N} \}$$

which will be used only in the selection of sₜ(t). Finally, for the third group let

$${Q}_{{m}_{{t}_{1}} \cdot 1} , {Q}_{{m}_{{t}_{1} \cdot 2}} , … , {Q}_{{m}_{{t}_{1} \cdot 1}} , = {I}_{{m}_{{t}_{2} \cdot 1}} , {I}_{{m}_{{t}_{1}} \cdot 2} , … , {I}_{{m}_{{t}_{2} \cdot 1}} ,$$

be a subset of L₃ elements of

$$\{ {E}_{Qk} {\vert}_{k = 1}^{N} \}$$

which will be used both for the selection of sₜ(t) and s_{Q}(t). Once again, since all of the output symbols of the Q encoder are used either to select s_{E}(t), s_{Q}(t) or both, then L₁+L₂+L₃=N.

A preferred mode exploits symmetry properties associated with the resulting modulation by choosing L₁=N₁, L₂=N₂ and L₃=N₃. However, the present invention is not restricted to this particular symmetry.

In summary, based on the above, the signal S_{E}(t) is determined from symbols

$${I}_{{t}_{1}} , {I}_{{t}_{2}} , … , {I}_{{l}_{{s}_{1 \cdot } {s}_{3}}}$$

from the output of the I encoder and symbols

$${I}_{{l}_{1}} , {I}_{{l}_{2}} , … , {I}_{{l}_{{L}_{2} \cdot {L}_{3}}}$$

from the output of the Q encoder. Thus, the size of the signaling alphabet used to select s_{E}(t) is 2^{N}^{₁}^{+N}^{₃}^{+L}^{₂}^{+L}^{₃}Δ2^{N}^{₁}. Similarly, the signal s_{Q}(t) is determined from symbols

$${Q}_{{l}_{1}} , {Q}_{{l}_{2}} , … , {Q}_{{l}_{1} \cdot {l}_{2}}$$

from the output of the Q encoder and symbols

$${Q}_{1} \cdot {Q}_{{l}_{2}} , … , {Q}_{{l}_{{s}_{2} \cdot {s}_{1}}}$$

from the output of the I encoder. Thus, the size of the signaling alphabet used to select S_{Q}(t) is 2^{N}^{₁}^{30 N}^{₃}^{+N}^{₂}^{+N}^{₃}Δ2^{N}^{_{Q}}.

An interesting embodiment results when the size of the signaling alphabets for selecting sₜ(t) and s_{Q}(t) are equal. In that case, Nₜ=N_{Q} or equivalently L₁+N₂=N₁+L₂. This condition is clearly satisfied if the condition L₁=N₁, =L₂=N₂ is met; however, the former condition is less restrictive and does not require the latter to be true.

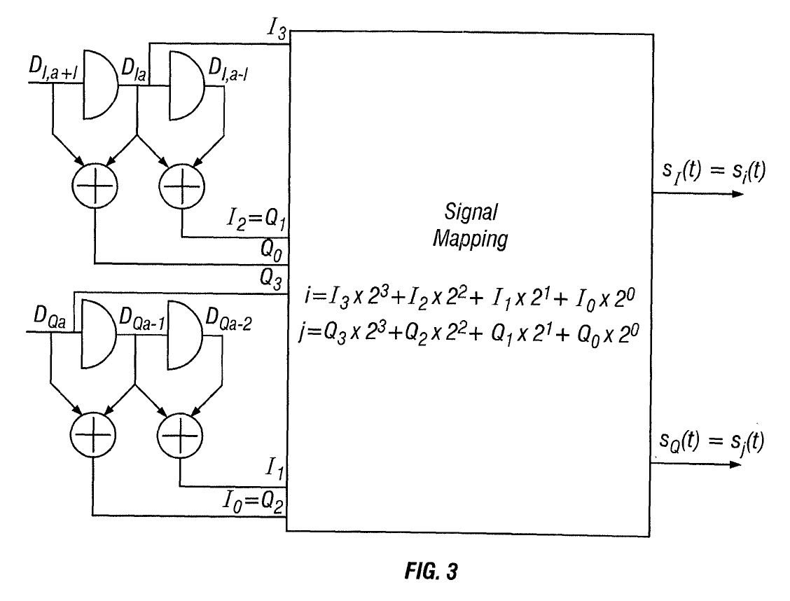

FIG. 3 shows an example of the above mapping corresponding to N₁=N₂=N₃=1 and L₁=L₂=L₃=1, i.e., r=1/N=⅓ encoders for FQPSK, which is one particular embodiment of the XTCQM invention. The specific symbol assignments for the three partitions of the I encoder output are I₃ (group 1), Q₀ (group 2), I₂=Q₁ (group 3). Similarly, the specific symbol assignments for the three partitions of the Q encoder output are: Q₃ (group 1), I₁ (group 2), I₀=Q₂ (group 3). Since N₁=N_{Q}=4, the size of the signaling alphabet from which both s_{E}(t) and s_{Q}(t) are to be selected has 2⁴=16 signals.

After assigning the encoder output symbols to either s_{E}(t), s_{Q}(t) or both, appropriate binary coded decimal (BCD) numbers are formed from these symbols. These numbers are used as indices i and j for selecting sᵢ(t) sⱼ(t) and s_{Q}(t)=s₁(t) where

$$\{ {s}_{i} ( t ) \vert \begin{matrix} {N}_{I} \\ i = 1\end{matrix} \} and \{ {s}_{j} ( t ) \vert \begin{matrix} {N}_{Q} \\ j = 1\end{matrix} \}$$

are the signal waveform sets assigned for transmission of the I and Q channel signals.

I₀,I₁, . . . , I_{N}_{₁} are defined as the specific set of symbols taken from both I and Q encoder outputs used to select sₜ(t) and s_{Q}(t). Then the BCD indices needed above are i=I_{N}_{₁}₋₁×2^{N}^{₁}⁻¹+ . . . +I₁×2¹+ . . . +I₀×2⁰ and j=Q_{N}_{_{Q}}₋₁×2^{N}^{_{Q}}⁻¹+ . . . +Q₁×2¹+ . . . +Q₀×2⁰. The FIG. 2 embodiment uses i=I₃×2³+I₂×2²+I₁×2¹ . . . +I₀×2⁰ and j=Q₃×2³+Q₂×2²+Q₁×2¹ . . . +Q₀×2⁰. This is shown in FIG. 3.

Numerically speaking, in a particular transmission interval of T [symbol] seconds, the contents of the I and Q encoders in FIG. 3 can be D_{1.n+1}=1,D₁ₙ=0,D_{1.n-1}=0 and D_{Q.n}=1,D_{Q.n-1}=0,D_{Q.n-2}=1, then the encoder output symbols

$$\{ {E}_{Ik} \vert \begin{matrix} 3 \\ k = 1\end{matrix} \} and \{ {E}_{Qk} \vert \begin{matrix} 3 \\ k = 1\end{matrix} \}$$

would respectively partition as Iᵢ=0 (group 1), Q₀=1 (group 2), I₂=Q₁=0 (group 3) and Qᵢ=1 (group 1), I₁=1 (group 2), I₀=Q₂=1 (group 3). Thus, based on the above, i=3 and j=13 and hence the selection for sₜ(t) and S_{Q}(t) would be s₁(t)=s₃(t) and s_{Q}(t)=s₁₃(t)

### The Signal Sets (Waveforms)

An important function of the present application is that any set of N₁ waveforms of duration T, seconds (defined on the interval (−T [symbol] /2≦t≦T,/2) can be used for selecting the I channel transmitted signal. Likewise, any set of N_{Q} waveforms of duration T [symbol] seconds, also defined on the interval (−T [symbol] /2≦t≦T [symbol] /2) can be used for selecting the Q channel transmitted signal s_{Q}(t). However, certain properties can be invoked on these waveforms to make them more power and spectrally efficient.

This discussion assumes the special case of N₁=N_{Q}ΔN^{*}, although other embodiments are contemplated. Maximum distance in the waveform set can improve power efficiency. The distance can be increased by dividing the signal set

$$\{ {s}_{i} ( t ) \vert \begin{matrix} {N}^{*} \\ i = 1\end{matrix} \}$$

into two equal parts; with the signals in the second part being antipodal to (the negatives of) those in the first part. Mathematically, the signal set has the composition s₀(t).s₁(t) . . . s_{N·2 1}(t),−s₀(t),−s₁(t), . . . ,−s_{N·2-1}(t). To achieve good spectral efficiency, one should choose the waveforms to be as smooth, i.e., as many continuous derivatives, as possible, since a smoother waveform gives better power spectrum roll off. Furthermore, to prevent discontinuities at the symbol transition time instants, the waveforms should have a zero first derivative (slope) at their endpoints t=±T [symbol] /2.

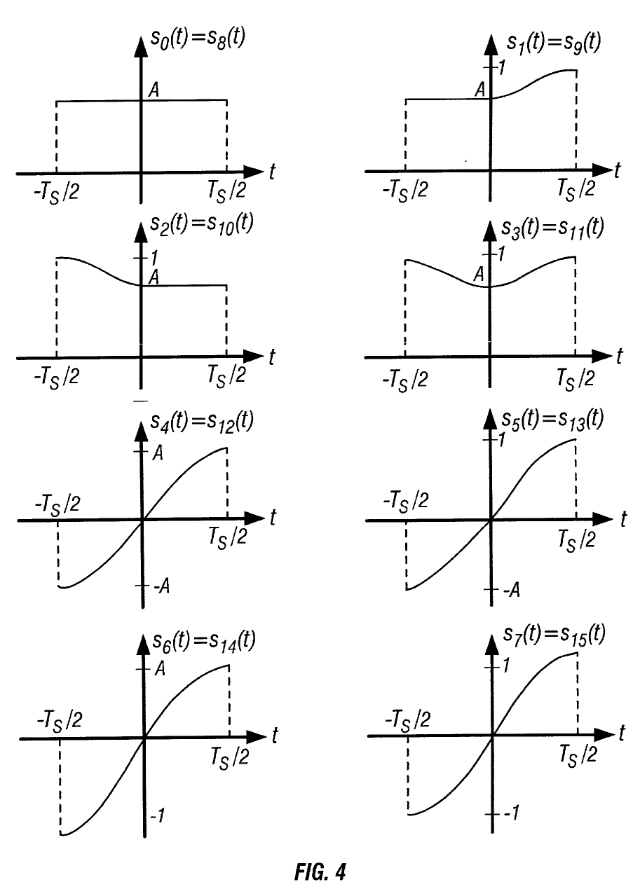

An example of a signal set that satisfies the first requirement and part of the second requirement is still illustrated in FIG. 4. This shows the specific FQPSK embodiment.

### Conventional FQPSK

Generic FQPSK is described in U.S. Pat. Nos. 4,567,602; 4,339,724; 4,644,565 and 5,491,457. This is conceptually similar to the cross-correlated phase-shift-keying (XPSK) modulation technique introduced in 1983 by Kato and Feher. This technique was in turn a modification of the previously-introduced (by Feher et al) interference and jitter free QPSK (IJF-QPSK) with the purpose of reducing the 3 dB envelope fluctuation characteristic of IJF-QPSK to 0 dB. This made the modulation appear as a constant envelope, which was beneficial in nonlinear radio systems. It is further noted that using a constant waveshape for the even pulse and a sinusoidal waveshape for the odd pulse, IJF-QPSK becomes identical to the staggered quadrature overlapped raised cosine (SQORC) scheme introduced by Austin and Chang. Kato and Feher achieved their 3 dB envelope reduction by using an intentional but controlled amount of crosscorrelation between the inphase (I) and quadrature (Q) channels. This crosscorrelation operation was applied to the IJF-QPSK (SQORC) baseband signal prior to its modulation onto the I and Q carriers.

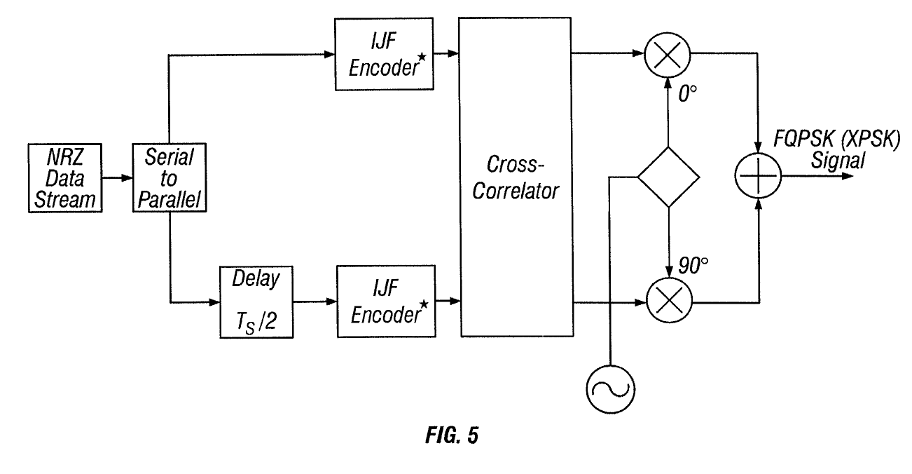

FIG. 5 shows a conceptual block diagram of FPQSK. Specifically, this operation has been described by mapping, in each half symbol, the 16 possible combinations of I and Q 20 channel waveforms present in the SQORC signal. The mapping moves the signals into a new set of 16 waveform combinations chosen in such a way that the crosscorrelator output is time continuous and has a unit (normalized) envelope at all I and Q uniform sampling instants.

The present embodiment describes restructuring the crosscorrelation mapping into one mapping, based on a full symbol representation of the I and Q signals. The FPQSK signal can be described directly in terms of the data transitions on the I and Q channels. As such, the representation becomes a specific embodiment of XTCQM.

Appropriate mapping of the transitions in the I and Q data sequences into the signals sₜ(t) and s_{Q}(t) is described by Tables 1 and 2.

TABLE 1
Mapping for Inphase (I)-Channel Baseband Signal
s_{I}(t) in the Interval (n − ½)T_{S} ≦ t < (n + ½)T_{S}

| $\vert \frac{{d}_{In} - {d}_{I n - 1}}{2} \vert$ | $\vert \frac{{d}_{Qn - 1} - {d}_{Qn - 2}}{2} \vert$ | $\vert \frac{{d}_{Qn} - {d}_{Qn - 1}}{2} \vert$ | s_{I}(t) |
|---|---|---|---|
| 0 | 0 | 0 | d_{In}s₀(t − nT₁) |
| 0 | 0 | 1 | d_{In}s₁(t − nT₁) |
| 0 | 1 | 0 | d_{In}s₂(t − nT₁) |
| 0 | 1 | 1 | d_{In}s₃(t − nT₁) |
| 1 | 0 | 0 | d_{In}s₄(t − nT₁) |
| 1 | 0 | 1 | d_{In}s₅(t − nT₁) |
| 1 | 1 | 0 | d_{In}s₆(t − nT₁) |
| 1 | 1 | 1 | d_{In}s₇(t − nT₁) |

TABLE 2
Mapping for Quadrature (Q)-Channel Baseband Signal
s_{Q}(t) in the Interval (n − ½)T₁ ≦ t ≦ (n + ½)T₁

| $\vert \frac{{d}_{Qn} - {d}_{Qn - 1}}{2} \vert$ | $\vert \frac{{d}_{Q n} - {d}_{Q n - 1}}{2} \vert$ | $\vert \frac{{d}_{Q n + 1} - {d}_{Q n}}{2} \vert$ | s_{Q}(t) |
|---|---|---|---|
| 0 | 0 | 0 | d_{Qn}s₀(t − nT₁) |
| 0 | 0 | 1 | d_{Qn}s₁(t − nT₁) |
| 0 | 1 | 0 | d_{Qn}s₂(t − nT₁) |
| 0 | 1 | 1 | d_{Qn}s₃(t − nT₁) |
| 1 | 0 | 0 | d_{Qn}s₄(t − nT₁) |
| 1 | 0 | 1 | d_{Qn}s₅(t − nT₁) |
| 1 | 1 | 0 | d_{Qn}s₆(t − nT₁) |
| 1 | 1 | 1 | d_{Qn}s₇(t − nT₁) |

Note that the subscript i of the transmitted signal s₁(t) or s_{Q}(t) as appropriate is the binary coded decimal (BCD) equivalent of the three transitions. Since dₜₙ and d_{Qn} take on values ±1, Tables 1 and 2 specify the mapping of I and Q symbol transitions 16 different waveforms, namely,

$${s}_{i} ( t ) \vert \begin{matrix} 15 \\ i = 0\end{matrix}$$

where s₁(t)=−s₁₋₈(t).i=8.9, . . . , 15.

The specifics are as follows:

$${s}_{0} ( t ) = A , - {T}_{s} / 2 \leq t \leq {T}_{s} / 2 , {s}_{8} ( t ) = - {s}_{0} ( t ) \\ {s}_{1} ( t ) = \{ \begin{matrix}A , - {T}_{s} / 2 \leq t \leq 0 & \\ 1 - ( 1 - A ) {cos}^{2} \frac{π t}{{T}_{s}} , & 0 \leq t \leq {T}_{s} / 2\end{matrix} {s}_{9} ( t ) = - {s}_{1} ( t ) \\ {s}_{2} ( t ) = \{ \begin{matrix}1 - ( 1 - A ) {cos}^{2} \frac{π t}{{T}_{s}} , & - {T}_{s} / 2 \leq t \leq 0 \\ A , 0 \leq t \leq {T}_{s} / 2 & \end{matrix} {s}_{10} ( t ) = - {s}_{2} ( t ) \\ {s}_{3} ( t ) = 1 - ( 1 - A ) {cos}^{2} \frac{π t}{{T}_{s}} , - {T}_{s} / 2 \leq t \leq {T}_{s} / 2 {s}_{11} ( t ) = - {s}_{3} ( t ) \\ and \\ {s}_{4} ( t ) = A sin \frac{π t}{{T}_{s}} , - {T}_{s} / 2 \leq t \leq {T}_{s} / 2 , {s}_{12} ( t ) = - {s}_{4} ( t ) \\ {s}_{5} ( t ) = \{ \begin{matrix}A sin \frac{π t}{{T}_{s}} , & - {T}_{s} / 2 \leq t \leq 0 \\ sin \frac{π t}{{T}_{s}} , & 0 \leq t \leq {T}_{s} / 2\end{matrix} , {s}_{13} ( t ) = - {s}_{5} ( t ) \\ {s}_{6} ( t ) = \{ \begin{matrix} sin \frac{π t}{{T}_{s}} , & - {T}_{s} / 2 \leq t \leq 0 \\ A sin \frac{π t}{{T}_{s}} , & 0 \leq t \leq {T}_{s} / 2\end{matrix} , {s}_{14} ( t ) = {s}_{6} ( t ) \\ {s}_{7} ( t ) = sin \frac{π t}{{T}_{s}} , - {T}_{s} / 2 \leq t \leq {T}_{s} / 2 , {s}_{15} ( t ) = {s}_{7} ( t ) \qquad ( \text{2a} )$$

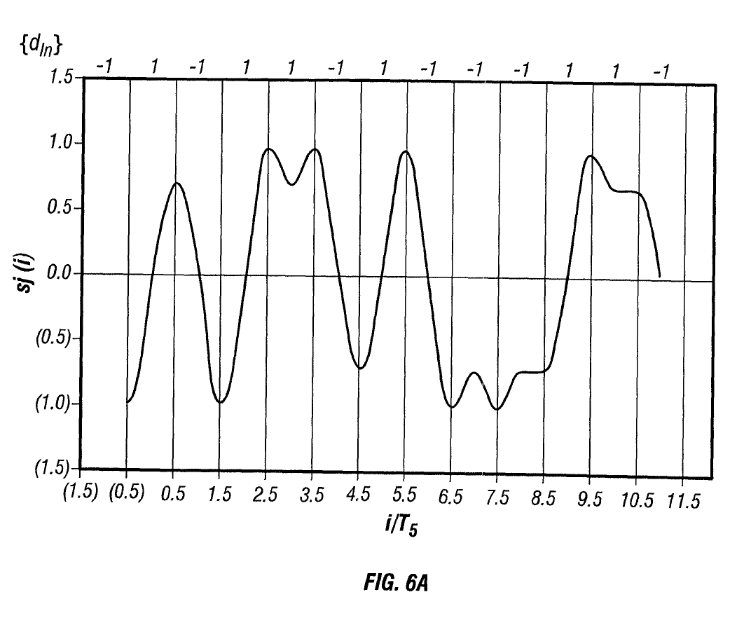

Applying the mappings in Tables 1 and 2 to the I and Q data sequences produces the identical I and Q baseband transmitted signals to those that would be produced by passing the I and Q IJF encoder outputs of FIG. 5 through the crosscorrelator (half symbol mapping) of the FQPSK (XPSK) scheme. An example of this is shown with reference to FIGS. 6a and 6b. The Q signal must be delayed by T [symbol] /2 to produce an offset form of modulation. Alternately stated, for arbitrary I and Q data sequences, FQPSK can alternately be generated by the symbol-by-symbol mappings of Tables 1 and 2 as applied to these sequences.

The mappings of Tables 1 and 2 become a specific embodiment of XTCQM as described herein. First, the I and Q transitions needed for the BCD representations of the indices of sᵢ(t) and sⱼ(t) are rewritten in terms of their modulo 2 sum equivalents. That is, using the (0,1) form of the I and Q data symbols, Tables 1 and 2 show that

i=I₃×2³+I₂×2²+I₁×2¹+I₀×2⁰

j=Q₃×2³+Q₂×2²Q₁×2¹+Q₀×2⁰ (3)

with

I₀=D_{Qn}⊕D_{Q.n-1}. Q₀=D_{1.n-1}⊕D₁ₙ

I₁=D_{Q n-1}⊕D_{Q.n-2}. Q₁=D₁ₙ⊕D_{1,n-1}=I₂

I₂=D₁ₙ⊕D_{1.n-1}. Q₂=D_{Qn}⊕D_{Qn-1}=I₀ (4)

I₃=D₁ₙ. Q₃=D_{Qn}

resulting in the baseband I and Q waveforms s₁(t)=s₁(t−nT,) and s_{Q}(t)=sⱼ(t−nT [symbol] ) The signals that are modulated onto the I and Q carriers are y₁(t)=s₁(t) and y_{Q}(t)=s_{Q}(t−T [symbol] /2). Thus, in each symbol interval

$$( ( n - \frac{1}{2} ) {T}_{s} \leq t \leq ( n + \frac{1}{2} ) {T}_{s}$$

for y₁(t) and nT≦t≦(n+1)T, for y_{Q}(t)), the I and Q channel baseband signals are each chosen from a set of 16 signals, s₁(t),i=0.1, . . . , 15 in accordance with the 4-bit BCD representations of their indices defined by (3) together with (4).

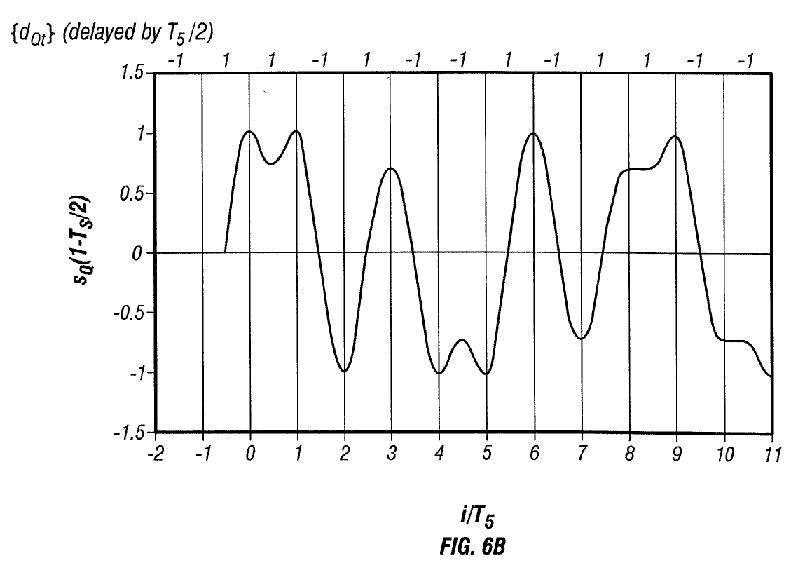

A graphical illustration of the implementation of this mapping is given in FIG. 3, which is a specific embodiment of FIG. 1 with N₁=N₂=N₃=L₁=L₂=L₃=1. The mapping in FIG. 3 can be interpreted as a 16-state trellis code with two binary inputs D_{1.n-1}.D_{Qn} and two waveform outputs sᵢ(t).sⱼ(t) where the state is defined by the 4-bit sequence D₁ₙ,D_{1.n-1}.D_{Q.n-1}.D_{Q.n-2}. The trellis is illustrated in FIG. 7 and the transition mapping is given in Table 3.

TABLE 3
Trellis State Transistions

| Current State | Input | Output | | Next State |
|---|---|---|---|---|
| 0 0 0 0 | 0 0 | 0 | 0 | 0 0 0 0 |
| 0 0 0 0 | 0 1 | 1 | 12 | 0 0 1 0 |
| 0 0 0 0 | 1 0 | 0 | 1 | 1 0 0 0 |
| 0 0 0 0 | 1 1 | 1 | 13 | 1 0 1 0 |
| 0 0 1 0 | 0 0 | 3 | 4 | 0 0 0 1 |
| 0 0 1 0 | 0 1 | 2 | 8 | 0 0 1 1 |
| 0 0 1 0 | 1 0 | 3 | 5 | 1 0 0 1 |
| 0 0 1 0 | 1 1 | 2 | 9 | 1 0 1 1 |
| 1 0 0 0 | 0 0 | 12 | 3 | 0 1 0 0 |
| 1 0 0 0 | 0 1 | 13 | 15 | 0 1 1 0 |
| 1 0 0 0 | 1 0 | 12 | 2 | 1 1 0 0 |
| 1 0 0 0 | 1 1 | 13 | 14 | 1 1 1 0 |
| 1 0 1 0 | 0 0 | 15 | 7 | 0 1 0 1 |
| 1 0 1 0 | 0 1 | 14 | 11 | 0 1 1 1 |
| 1 0 1 0 | 1 0 | 15 | 6 | 1 1 0 1 |
| 1 0 1 0 | 1 1 | 14 | 10 | 1 1 1 1 |
| 0 0 0 1 | 0 0 | 2 | 0 | 0 0 0 0 |
| 0 0 0 1 | 0 1 | 3 | 12 | 0 0 1 0 |
| 0 0 0 1 | 1 0 | 2 | 1 | 1 0 0 0 |
| 0 0 0 1 | 1 1 | 3 | 13 | 1 0 1 0 |
| 0 0 1 1 | 0 0 | 1 | 4 | 0 0 0 1 |
| 0 0 1 1 | 0 1 | 0 | 8 | 0 0 1 1 |
| 0 0 1 1 | 1 0 | 1 | 5 | 1 0 0 1 |
| 0 0 1 1 | 1 1 | 0 | 9 | 1 0 1 1 |
| 1 0 0 1 | 0 0 | 14 | 3 | 0 1 0 0 |
| 1 0 0 1 | 0 1 | 15 | 15 | 0 1 1 0 |
| 1 0 0 1 | 1 0 | 14 | 2 | 1 1 0 0 |
| 1 0 0 1 | 1 1 | 15 | 14 | 1 1 1 0 |
| 1 0 1 1 | 0 0 | 13 | 7 | 0 1 0 1 |
| 1 0 1 1 | 0 1 | 12 | 11 | 0 1 1 1 |
| 1 0 1 1 | 1 0 | 13 | 6 | 1 1 0 1 |
| 1 0 1 1 | 1 1 | 12 | 10 | 1 1 1 1 |
| 0 1 0 0 | 0 0 | 4 | 2 | 0 0 0 0 |
| 0 1 0 0 | 0 1 | 5 | 14 | 0 0 1 0 |
| 0 1 0 0 | 1 0 | 4 | 3 | 1 0 0 0 |
| 0 1 0 0 | 1 1 | 5 | 15 | 1 0 1 0 |
| 0 1 1 0 | 0 0 | 7 | 6 | 0 0 0 1 |
| 0 1 1 0 | 0 1 | 6 | 10 | 0 0 1 1 |
| 0 1 1 0 | 1 0 | 7 | 7 | 1 0 0 1 |
| 0 1 1 0 | 1 1 | 6 | 11 | 1 0 1 1 |
| 1 1 0 0 | 0 0 | 8 | 1 | 0 1 0 0 |
| 1 1 0 0 | 0 1 | 9 | 13 | 0 1 1 0 |
| 1 1 0 0 | 1 0 | 8 | 0 | 1 1 0 0 |
| 1 1 0 0 | 1 1 | 9 | 12 | 1 1 1 0 |
| 1 1 1 0 | 0 0 | 11 | 5 | 0 1 0 1 |
| 1 1 1 0 | 0 1 | 10 | 9 | 0 1 1 1 |
| 1 1 1 0 | 1 0 | 11 | 4 | 1 1 0 1 |
| 1 1 1 0 | 1 1 | 10 | 8 | 1 1 1 1 |
| 0 1 0 1 | 0 0 | 6 | 2 | 0 0 0 0 |
| 0 1 0 1 | 0 1 | 7 | 14 | 0 0 1 0 |
| 0 1 0 1 | 1 0 | 6 | 3 | 1 0 0 0 |
| 0 1 0 1 | 1 1 | 7 | 15 | 1 0 1 0 |
| 0 1 1 1 | 0 0 | 5 | 6 | 0 0 0 1 |
| 0 1 1 1 | 0 1 | 4 | 10 | 0 0 1 1 |
| 0 1 1 1 | 1 0 | 5 | 7 | 1 0 0 1 |
| 0 1 1 1 | 1 1 | 4 | 11 | 1 0 1 1 |
| 1 1 0 1 | 0 0 | 10 | 1 | 0 1 0 0 |
| 1 1 0 1 | 0 1 | 11 | 13 | 0 1 1 0 |
| 1 1 0 1 | 1 0 | 10 | 0 | 1 1 0 0 |
| 1 1 0 1 | 1 1 | 11 | 12 | 1 1 1 0 |
| 1 1 1 1 | 0 0 | 9 | 5 | 0 1 0 1 |
| 1 1 1 1 | 0 1 | 8 | 9 | 0 1 1 1 |
| 1 1 1 1 | 1 0 | 9 | 4 | 1 1 0 1 |
| 1 1 1 1 | 1 1 | 8 | 8 | 1 1 1 1 |

In this table, the entries in the column labeled “input” correspond to the values of the two input bits D_{1.n+1},D_{Qn} that result in the transition. The entries in the column “output” correspond to the subscripts i and j of the pair of symbol waveforms sᵢ(t),sⱼ(t) that are output.

### Enhanced FQPSK

It is well known that the rate at which the sidelobes of a modulation's power spectral density (PSD) roll off with frequency is related to the smoothness of the underlying waveforms that generate it. That is, a waveform that has more continuous waveform derivatives will hare faster Fourier transform decays with frequency.

The crosscorrelation mappings of FQPSK is based on a half symbol characterization of the SQORC signal. Hence, there is no guarantee that the slope or any higher derivatives of the crosscorrelator output waveform is continuous at the half symbol transition points. From Equation (2b) and the corresponding illustration in FIG. 4, it can be observed that four out of the sixteen possible transmitted waveforms, namely, s₅(t),s₆(t),s₁₃(t),s₁₄(t) have a slope discontinuity at their midpoint. Thus, for random I and Q data symbol sequences, on the average the transmitted FQPSK waveform will likewise have a slope discontinuity at one quarter of the uniform sampling time instants. Therefore, for a random data input sequence, a discontinuity in slope occurs one quarter of the time.

Based on the above reasoning, it is predicted that an improvement in PSD rolloff could be obtained if the FQPSK crosscorrelation mapping could be modified so that the firs, derivative of the transmitted baseband waveforms is always continuous. This enhanced version of FQPSK requires a slight modification of the above-mentioned four waveforms in FIG. 4. In particular, these four transmitted signals are redefined in a manner analogous to s₁(t),s₂(t),s₉(t),s₁₀(t), namely

$${s}_{5} ( t ) = \{ \begin{matrix} sin \frac{π t}{{T}_{s}} + ( 1 - A ) {sin}^{2} \frac{π t}{{T}_{s}} , - {T}_{s} / 2 \leq t \leq 0 \\ sin \frac{π t}{{T}_{s}} , 0 \leq t \leq {T}_{s} / 2\end{matrix} , {s}_{13} ( t ) = - {s}_{5} ( t ) \\ {s}_{6} ( t ) = \{ \begin{matrix} sin \frac{π t}{{T}_{s}} , - {T}_{s} / 2 \leq t \leq 0 \\ sin \frac{π t}{{T}_{s}} - ( 1 - A ) {sin}^{2} \frac{π t}{{T}_{s}} , 0 \leq t \leq {T}_{s} / 2\end{matrix} , {s}_{14} ( t ) = - {s}_{6} ( t ) \qquad ( 5 )$$

Note that not only do the signals s₅(t),s₆(t),s₁₃(t),s₁₄(t) as defined in (5) not have a slope discontinuity at their midpoint, or anywhere else in the defining interval. Also, the zero slope at their endpoints has been preserved. Thus, the signals in (5) satisfy both requirements for desired signal set waveforms as discussed in Section 3.1.2. Using (5) in place of the corresponding signals of (2b) results in a modified FQPSK signal that has no slope discontinuity anywhere in time regardless of the value of A.

FIG. 5 illustrates a comparison of the signal s₀(t) of (5) with that of (2b) for a value of A=1/\sqrt{2}.

The signal set selected for enhanced FQPSK has a symmetry property for s₀(t)−s₃(t) that is not present for s₄(t)−s₇(t). In particular, s₁(t) and s₂(t) are each composed of one half of s₀(t) and one half of s₃(t), i.e., the portion of S₁(t) from t=−T,/2 to t=0 is the same as that one half of s₀(t) whereas the portion of s₁(t) from t=0 to t=T,/2 is the same as that of s₃(t) and vice versa for s₂(t). To achieve the same symmetry property for s₄(t)−s₇(t), one would have to reassign s₄(t) as

$${s}_{4} ( t ) = \{ \begin{matrix}sin \frac{π t}{{T}_{s}} + ( 1 - A ) {sin}^{2} \frac{π t}{{T}_{s}} , - {T}_{s} / 2 \leq t \leq 0 \\ sin \frac{π t}{{T}_{s}} - ( 1 - A ) {sin}^{2} \frac{π t}{{T}_{s}} , 0 \leq t \leq {T}_{s} / 2\end{matrix} , {s}_{12} ( t ) = - {s}_{4} ( t ) \qquad ( 6 )$$

This minor change produces a complete symmetry in the waveform set. Thus, it has an advantage from the standpoint of hardware implementation and produces a negligible change in spectral properties of the transmitted waveform. The remainder of the discussion, however, ignores this minor change and assumes the version of enhanced FQPSK first introduced in this section.

### Trellis Coded OQPSK

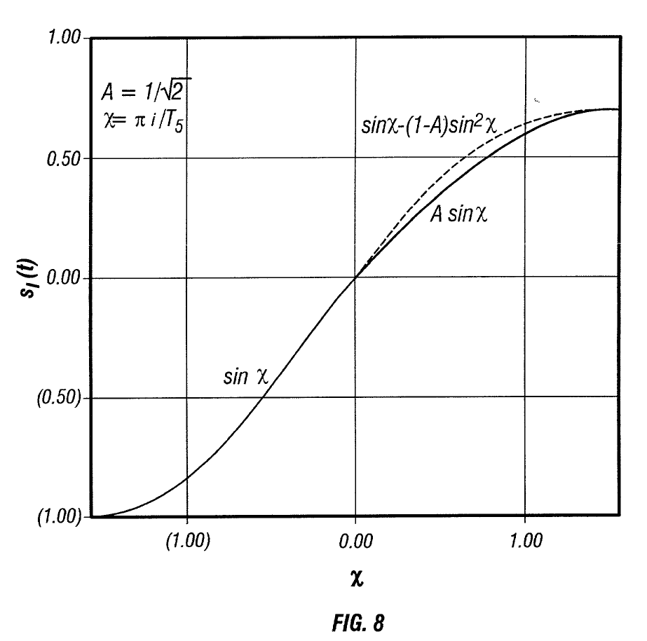

Consider an XTCQM scheme in which the mapping function is performed identically to that in the FQPSK embodiment (i.e., as in FIG. 3) but the waveform assignment is made as follows and as shown in FIG. 9:

$$\begin{matrix}{s}_{0} ( t ) = {s}_{1} ( t ) = {s}_{2} ( t ) = {s}_{3} ( t ) = 1 , & - {T}_{s} / 2 \leq t \leq {T}_{s} / 2 ,\end{matrix} \\ {s}_{4} ( t ) = {s}_{5} ( t ) = {s}_{6} ( t ) = {s}_{7} ( t ) = \{ \begin{matrix}- 1 , & - {T}_{s} / 2 \leq t \leq 0 \\ 1 , & 0 \leq t \leq {T}_{s} / 2\end{matrix} \\ {s}_{i} ( t ) = - {s}_{i - 8} ( t ) , i = 8 , 9 , … , 15 \qquad ( 7 )$$

that is, the first four waveforms are identical (a rectangular pulse) as are the second four (a split rectangular unit pulse) and the remaining eight waveforms are the negatives of the first eight. As such there are only four unique waveforms which are denoted by

$${c}_{i} ( t ) {\vert}_{i = 0}^{3}$$

where c₀(t)=s₀(t).c₁(t)=s₄(t),c₂(t)=s₈(t),c₃(t)=s₁₂(t). Since the BCD representations for each group of four identical waveforms the two least significant bits are irrelevant, i.e., the two most significant bits are sufficient to define the common waveform for each group, the mapping scheme can be simplified by eliminating the need for I₀.I₁ and Q₀.Q₁. FIG. 3 shows how eliminating all of I₀.I₁ and Q₀.Q₁ accomplishes multiple purposes. The two encoders can be identical and need only a single shift register stage. Also, the correlation between the two encoders in so far as the mapping of either one's output symbols to both sₜ(t) and s_{Q}(t) has been eliminated which therefore results in what: might be termed a “degenerate” form of XTCQM.

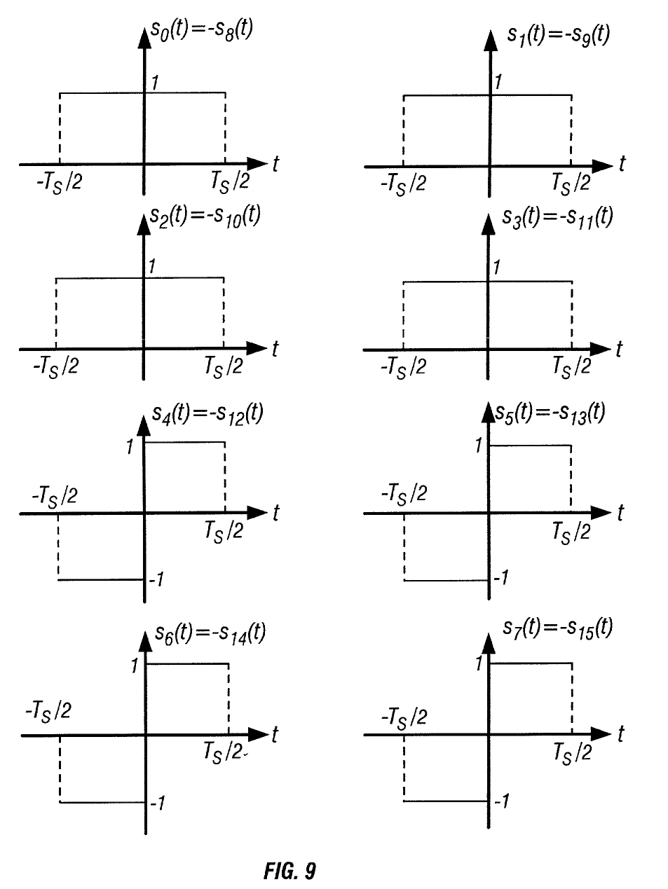

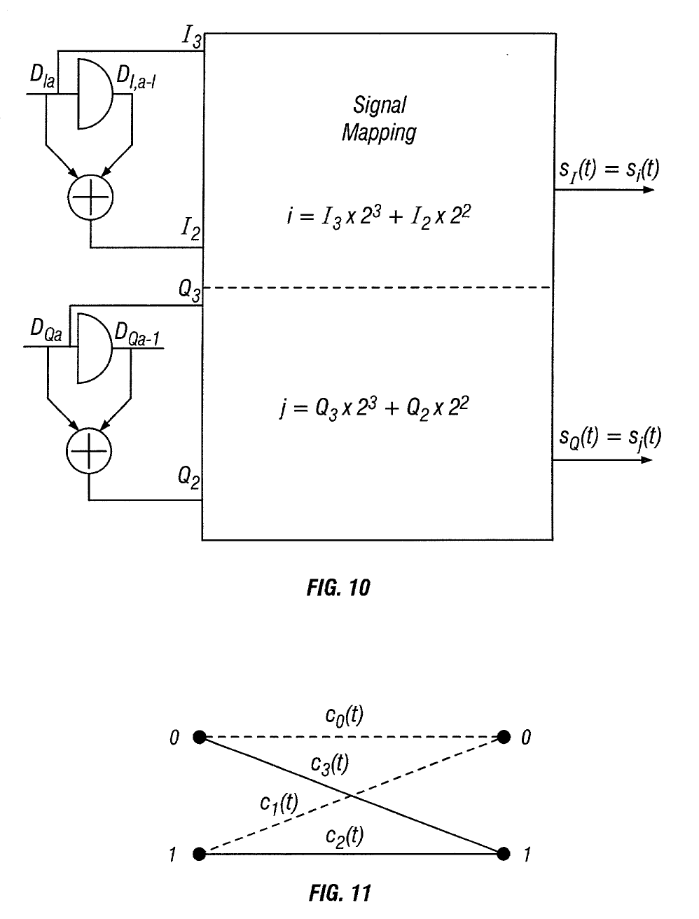

The resulting embodiment is illustrated in FIG. 10. Since the mapping decouples the I and Q as indicated by the dashed line in the signal mapping block of FIG. 10, it is sufficient to examine the trellis structure and its distance properties for only one of the two I and Q channels. The trellis diagram for either channel of this modulation scheme would have two states as illustrated in FIG. 11. The dashed line indicates a transition caused by an input “0” and the solid indicates a transition caused by an input “1”. Also, the branches are labeled with the output signal waveform that results from the transition. An identical trellis diagram exists for the Q channel.

This embodiment of XTCQM has a PSD identical to that of the uncoded OQPSK (which is the same as uncoded QPSK) for the transmitted signal. In particular, because of the constraints imposed by the signal mapping, the waveforms C₁(t)=s₄(t) and c₃(t)=s₁₂(t) can never occur twice in succession. Thus, for any input information sequence, the sequence of signals sₜ(t) and s_{Q},(t) cannot transition at a rate faster than 1/T,sec. This additional spectrum conservation constraint imposed by the signal mapping function of XTCQM can reduce the coding (power) gain relative to that which could be achieved with another mapping which does not prevent the successive repetition of c₁(t) and c₃(t) However, the latter occurrence would result in a bandwidth expansion by a factor of two.

### Trellis Coded SQORC

If instead of a split rectangular pulse in (7), a sinusoidal pulse were used, namely,

$${s}_{4} ( t ) = {s}_{5} ( t ) = {s}_{6} ( t ) = {s}_{7} ( t ) = sin \frac{π t}{{T}_{s}} , - {T}_{s} / 2 \leq t \leq {T}_{s} / 2 \\ {s}_{i} ( t ) = - {s}_{i - 8} ( t ) , i = 12 , 13 , 14 , 15 \qquad ( 8 )$$

then the same simplification of the mapping function as in FIG. 10 occurs resulting in decoupling of the I and Q channels. The trellis diagram of FIG. 11 can then be used for either the I or Q channel. Once again, this has a PSD identical to that of uncoded SQORC which is the same as uncoded QORC.

### Uncoded OQPSK

The signal assignment and mapping of FIG. 3 can be simplified such that

s₀(t)=s₁(t)= . . . =s₇(t)=1. −T [symbol] /2≦t≦T [symbol] /2.

s₁(t)=−s₁₋₈(t).i=8.9, . . . , 15 (9)

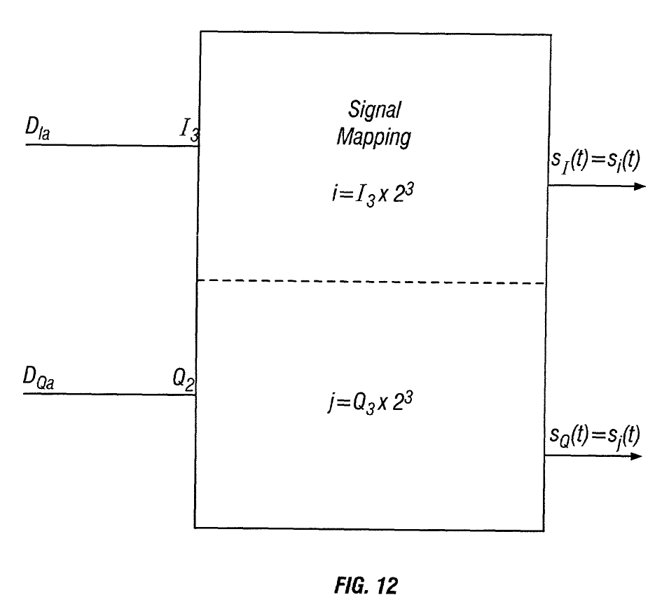

then in the BCD representations for each group of eight identical waveforms the three least significant bits are irrelevant. Only the first significant bit is needed to define the common waveform for each group. Hence, the mapping scheme can be simplified by eliminating the need for I₀,I₁,I₂ and Q₀,Q₁,Q₂. Defining the two unique waveforms c₀(t)=s₀(t),c₁(t)=s₈(t) obtains the simplified degenerate mapping of FIG. 12 which corresponds to uncoded OQPSK with NRZ data formatting.

Likewise, if instead of the signal assignment in (9) the relation below is used:

$${s}_{0} ( t ) + {s}_{1} ( t ) = … = {s}_{7} ( t ) \{ \begin{matrix}- 1 , & - {T}_{s} / 2 \leq t \leq 0 \\ 1 , & 0 \leq t \leq {T}_{i} / 2\end{matrix} \\ {s}_{i} ( t ) = - {s}_{i - 8} ( t ) , i = 8.9 , … , 15 \qquad ( 10 )$$

then the mapping of FIG. 12 produces uncoded OQPSK with Manchester (biphase) data formatting.

### Receiver Implementation and Performance

An optimum detector for XTCQM is a standard trellis coded receiver which employs a bank of filters which are matched to the signal waveform set, followed by a Viterbi (trellis) decoder. The bit error probability (BEP) performation of such a receiver can be described in terms of its minimum squared Euclidean distance dₘᵢₙ², taken over all pairs of paths through the trellis. Comparing dₘᵢₙ² for one TCM scheme with that of another scheme or with an uncoded modulation provides a measure of the relative asymptotic coding gain in the limit of infinite Eₕ/N₀. To compute dₘᵢₙ² for a given TCM (of which XTCQM is one), it is sufficient to determine the minimum Euclidean distance over all pairs of error event paths that emanate from a given state, and first return to that or another state a number of branches later.

The procedure and actual coding gains that can be achieved relative to uncoded OQPSK are explained with reference to results for the specific embodiments of XTCQM discussed above.

### FQPSK

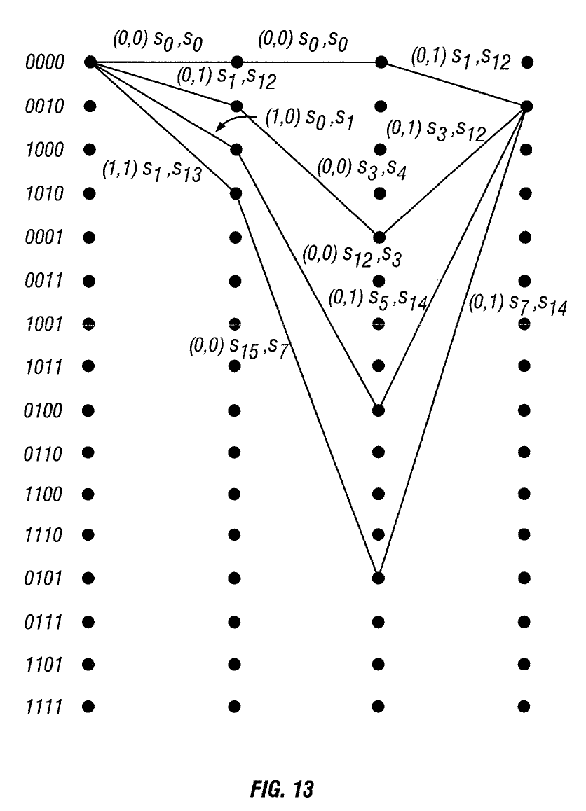

For conventional or enhanced FQPSK, the smallest length error event for which there are at least two paths that start in one state and remerge in the same or another state is 3 branches. For each of the 16 starting states, there are exactly 4 such error event paths that remerge in each of the 16 end states. FIG. 13 is an example of these error event paths for the case where the originating state is “0000” and the terminating state is “0010”.

The trellis code defined by the mapping in Table 3 is not uniform, e.g., it is not sufficient to consider only the all zeros path as the transmitted path in computing the minimum Euclidean distance. Rather all possible pairs of error event paths starting from each of the 16 states (the first 8 states are sufficient in view of the symmetry of the signal set) and the ending in each of the 16 states and must be considered to determine the pair having the minimum Euclidean distance.

Upon examination of the squared Euclidean distance between all pairs of paths, regardless of length, it has been shown that the minimum of this distance normalized by the average bit energy which is one half the average energy of the signal (symbol) set, is for FQPSK given by

$$\frac{{d}_{mm}^{2}}{2 {\overline{E}}_{h}} = \frac{16 [ \frac{7}{4} - \frac{8}{3 π} - A ( \frac{3}{2} + \frac{4}{3 π} ) + {A}^{2} ( \frac{11}{4} + \frac{4}{π} ) ]}{( 7 + 2 A + 15 {A}^{2} )} = 1.56 \qquad ( 11 )$$

where \overline{E}ₕ denotes the average bit energy of the FQPSK signal set, i.e., one-half the average symbol energy of the same signal set. For enhanced FQ2SK we have

$$\frac{{d}_{mm}^{2}}{2 {\overline{E}}_{h}} = \frac{( 3 - 6 A + 15 {A}^{2} )}{\frac{21}{8} - \frac{8}{3 π} - A ( \frac{1}{4} - \frac{8}{3 π} ) + \frac{29}{8} {A}^{2}} = 1.56 \qquad ( 12 )$$

which coincidentally is identical to that for FQPSK. Thus, the enhancement of FQPSK provided by using the waveforms of (5) as replacements for their equivalents in (2b) is significantly beneficial from a spectral standpoint with no penalty in asymptotic receiver performance.

To compare the performance of the optimum receivers of FQPSK and enhanced FQPSK with that of conventional uncoded offset QPSK (OQPSK) we note for the latter that dₘᵢₙ²/\overline{E}ₕ=2 which is the same as that for BPSK. Thus, as a trade against the significantly improved power spectrum afforded by FQPSK and its enhanced version relative to that of OQPSK, an asymptotic loss of only 10 log(1/1.56)=1.07 dB is experienced. These results should be compared with the significantly poorer performance of the conventional FQPSK receiver which makes symbol-by-symbol decisions based independently on the I and Q samples, and results in an asymptotic loss in Eₕ/N₀ performance on the order of 2 to 2.5 dB relative to uncoded OQPSK.

### Trellis Coded OQPSK

For the 2-state trellis diagram in FIG. 11, the minimum squared Euclidean distance occurs for an error event path of length 2 branches. Considering the four possible pairs of such paths that eminate from one of the 2 states and remerge at the same or the other state, then for the waveforms of FIG. 9 it is simple to see that dₘᵢₙ²=4T [symbol] . Since the average energy of the signal (symbol) set on the I (or Q) channel is Eᵤᵥ=Tₛ which is also equal to the average bit energy (since the channel by itself represents only one bit of information), then the normalized minimum squared Euclidean distance is dₘᵢₙ²/2\overline{E}ₕ=2 which represents no asymptotic coding gain over OQPSK. At finite values of Eₕ/N₀ there will exist some coding gain since the commutation of error probability performance takes into account all possible error event paths, i.e., not only those corresponding to the minimum distance. Thus, in conclusion, the trellis coded OQPSK scheme presented here is a method for generating a transmitted modulation with a PSD that is identical to that of uncoded OQPSK and offers the potential of coding gain at finite SNR without the need for transmitting a higher order modulation (e.g., conventional rate ⅔ trellis coded 8PSK with also achieves no bandwidth expansion relative to uncoded QPSK), the latter being significant in that receiver synchronization circuitry can be designed for a quadriphase modulation scheme.

### Trellis Coded SQORC

Here again the minimum squared Euclidean distance occurs for the same error event paths as described above. With reference to the signal waveform, we now have dₘᵢₙ²=3T,. Since the average energy of this signal (symbol) set is Eᵤᵥ=0.75T, which again per channel is equal to the average bit energy, then the normalized minimum squared Euclidean distance is also dₘᵢₙ²/2\overline{E}ₕ=2 which again represents no asymptotic coding gain over SQORC. Even though its pulse shaping SQORC has an improved PSD relative to OQPSK, it suffers from a 3 dB envelope fluctuation whereas OQPSK is constant envelope.

1. A method of a coding a signal, comprising:
mapping multiple possible combinations of waveforms to full symbols of bits from both in phase (I) and quadrature (Q) channels, said mapping being such that mapping output is time synchronous over multiple symbols, and has a normalized envelope over all symbols; and
applying input signals from both I and Q channels to said mapping to form a coded waveform representing said signals.

2. A method as in claim 1, wherein said mapping comprises forming a mapping of a FPQSK signal.

3. A method as in claim 2, wherein said mapping comprises investigating in phase bits, investigating quadrature bits, and classing said bits as either:
1) applying only to the in phase signal,
2) applying only to the quadrature signal, or
3) applying both to the in phase and to the quadrature signal.

4. A method as in claim 2, wherein said mapping forms an output which does not include any slope discontinuities at transitions between different waveforms.

5. A method as in claim 3, further comprising defining a binary coded decimal representation of said bits.

6. A method, comprising:
forming full symbol mappings between in phase (I) and quadrature (Q) bitstreams;
producing an output coded waveform representative of the in phase and quadrature bitstreams;
delaying one of said bitstreams by half a symbol so that both I and Q parts of the bitstreams are simultaneously available; and
using both said I and Q parts to obtain one of said mappings.

7. A method, comprising:
obtaining a data stream of bits;
separating said stream into in phase and quadrature sequences;
delaying one of said sequences to form time synchronous I and Q sequences; and
coding a full symbol of the I and Q sequences into coded waveforms indicative thereof.

8. A method as in claim 7 wherein said coding comprises mapping signal sets onto functions using a waveform having a specified waveshape.

9. A method as in claim 8, wherein said mapping comprises cross correlating among the I and Q signals.

10. A method as in claim 9 wherein said cross correlating comprises, for each signal I, determining a subset which will be used to determine only an I part of the function, and determining a second subset which will be used to determine only a Q part of the function, and determining a third subset which will be used to determine both I and Q parts of the function.

11. A method as in claim 10 wherein said cross correlating comprises, for each signal Q, determining a subset which will be used to determine only an I part of the function, and determining a second subset which will be used to determine only a Q part of the function, and determining a third subset which will be used to determine both I and Q parts of the function.

12. A method as in claim 10, further comprising determining the I part of the function from the first subset of both the I and Q signals.

13. A method as in claim 11, wherein said signals are obtained to a code according to a FQPSK coding scheme.

14. A method as in claim 11 further comprising defining symbols according to numbers, and obtaining binary coded decimal indices for said numbers.

15. A method as in claim 7, further comprising mapping said signals to waveforms, wherein said waveforms are selected such that a waveform for an entire symbol has zero slope at its end points, such that there is zero slope discontinuity between symbol transitions in waveforms.

16. A method as in claim 15, wherein said waveforms also have no slope discontinuities within each waveform.

17. A coding system, comprising:
a serial to parallel converter, receiving a plurality of bits at an input thereof, and providing said bits to both an in phase and a quadrature channel;
using both of said in phase and quadrature channels to code said bits as a waveform, by cross correlating and mapping said signals to a specified waveform based on a waveform table which maps between full symbols and coded outputs of said in phase and quadrature channels;
delaying one of said in phase and quadrature channels relative to the other to ensure time synchronicity; and
transmitting the waveforms to represent said plurality of bits.

18. A system as in claim 17 wherein said cross correlating comprises separating said signals into I only portions from both the I and Q channels, Q only portions from both the I and Q channels, and I and Q portions from both the I and Q channels.

19. A system as in claim 18, wherein said mapping comprises determining a plurality of waveforms for a specified coding scheme based on full symbol mappings; and encoding each of said signals according to said mapping.

20. A system as in claim 19 wherein said symbols are FQPSK symbols.

21. A system as in claim 19 wherein said symbols are FQPSK symbols, which are modified to remove slope discontinuities between different parts of the symbols.

22. A method, comprising:
forming a table which correlates between full symbol encoder outputs and specified outputs of a specified coding system using symbol by symbol mappings; and
using input data sequences to form outputs in the specified coding system.

23. The method as in claim 22 wherein the specified coding system is an FQPSK system.

24. A method as in claim 22, wherein said using comprises mapping specified bits to specified signals without storing said signals in a memory.

25. A method as in claim 22 wherein said using comprises determining, from each of the I and Q channels, bits which represent only I information, bits which represent only Q information, and bits which represent both I and Q information, and using said bits to form the outputs.

26. A method as in claim 25 wherein said bits are used to form mappings in pairs of I and Q bits to form FQPSK signals.

27. A method as in claim 25 wherein said coding is for FQPSK.

28. A method as in claim 27, further comprising determining a slope discontinuity in points between different parts of the multiple possible transmitted waveforms, and modifying the waveforms according to
$${s}_{5} ( t ) = \{ \begin{matrix}sin \frac{π t}{{T}_{i}} + ( 1 - A ) {sin}^{2} \frac{π t}{{T}_{i}} , & - {T}_{i} / 2 \leq t \leq 0 \\ sin \frac{π t}{{T}_{i}} , 0 \leq t \leq {T}_{i} / 2 & \end{matrix} , {s}_{13} ( t ) = - {s}_{5} ( t ) \\ {s}_{6} ( t ) = \{ \begin{matrix}sin \frac{π t}{{T}_{i}} , - {T}_{i} / 2 \leq t \leq 0 & \\ sin \frac{π t}{{T}_{i}} - ( 1 - A ) {sin}^{2} \frac{π t}{{T}_{i}} , & 0 \leq t \leq {T}_{i} / 2 \end{matrix} , {s}_{14} ( t ) = - {s}_{6} ( t )$$

29. A method as in claim 22, wherein said mapping comprises a modified method of FQPSK mapping which does not have a slope discontinuity at its midpoint.
